(19) United States
(12) Patent Application Publication
(10) Pub. No.: US 2008/0131057 A1
(43) Pub. Date: Jun. 5, 2008

(54) Fiber optic wall outlet with slack storage

(76) Inventor: Danny McGranahan, Ft. Worth, TX (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/634,067

(22) Filed: Dec. 5, 2006

(51) Int. Cl. G02B 6/38

(52) U.S. Cl. 385/75

(57) ABSTRACT

There is provided a wall outlet with at least one optical fiber adapter, wherein the wall outlet provides slack storage for an optical fiber generally routed through the wall. The wall outlet comprises a panel that includes at least one optical fiber routing guide adapted to provide slack storage for the optical fiber generally routed though the wall. The panel may be moveably joined to the wall outlet body and the optical fiber routing guide may define a minimum bend radius of less than about one inch. The wall outlet provides improved storage of optical fiber slack that may be utilized when optically connecting an optical fiber to the optical fiber adapter.

### BACKGROUND OF THE INVENTION

1. Field of the Invention

The present invention is related to fiber optic devices, and more particularly, to fiber optic wall outlets adapted for optical fiber slack storage.

2. Description of Related Art

As optical fiber is increasingly being provided in houses, offices, and other premises for telecommunication services, additional customer or subscriber products are becoming available that are adapted to directly receive the optical signals transmitted through the optical fibers. Examples of such products include computers, entertainment centers, communication systems, and the like. In order for optical fibers to connect directly to the customer product, it is often desired to provide a wall outlet in a room, office, or the like to allow customers to directly plug an optical fiber from the wall outlet to the product. Furthermore, it is often desirable to provide slack storage with the wall outlet to enable the customer to have more freedom when connecting products and/or to assist in the installation of the optical fiber generally routed through the wall. However, it is desired to provide protection for the stored slack of optical fibers as providing slack storage within the wall itself may damage the optical fibers or diminish the performance of the optical fibers if the optical fibers unintentionally come into contact with other objects and/or the minimum bend radius of the optical fibers is unintentionally compromised.

Examples of prior art wall outlets are provided in FIGS. 1 and 2. However, each of these wall outlets has drawbacks that prevent its widespread use. The wall outlet 10 of FIG. 1 includes a body 12 to which is joined an optical fiber adapter 14, wherein the optical fiber adapter is optically connected to the optical fiber 16 generally routed through the wall 18 and provides a receptacle to receive a connector of an optical fiber provided outside the wall such as the customer optical fiber. The wall outlet 10 comprises a slack storage portion 20 that generally extends into the wall to provide slack storage about a plane that is generally orthogonal to the face (outwardly-facing portion) of the wall outlet. The slack storage portion 20 is required to be a certain depth to provide the desired minimum bend radius for the optical fiber 16 generally routed through the wall 18. This depth can prevent the wall outlet 10 from being used in certain situations, such as where the wall thickness is not sufficient and/or the depth complicates the assembly of the wall outlet into certain other walls. Therefore, a need exists for a wall outlet that provides an overall smaller depth.

The wall outlet 30 of FIG. 2 provides a smaller depth; however, the face of the wall outlet defines an area that is of rather large size. FIG. 2 illustrates the wall-facing portion of the wall outlet 30, wherein the wall outlet provides adapters for optical fibers 32 and 34, and/or copper connections 36 and 38. The wall-facing portion 40 of the wall outlet 30 includes at least one optical fiber routing guide 42 which includes a generally cylindrical rim 44 and/or radially extending tabs 46. The optical fibers 32 and 34 are generally routed through the wall and then about the optical fiber routing guide 42. Because the slack storage of the optical fibers 32 and 34 is generally coplanar with the face of the wall outlet 30, the wall outlet defines a relatively large face in order for the optical fiber routing guide to provide the minimum bend radius for the optical fibers. Wall outlets with such large faces are undesirable in many applications because they take up a large amount of wall surface area and/or may not be conveniently installed in the wall due to the large size.

Therefore a need exists for fiber optic wall outlets that provide slack storage for optical fibers. Furthermore, a need exists for fiber optic wall outlets that define a reasonable depth and surface area so that the wall outlet may be conveniently installed in a variety of situations.

### BRIEF SUMMARY OF THE INVENTION

The various embodiments of the present invention address the above needs and achieve other advantages by providing wall outlets that comprise at least one optical fiber routing guide defining a minimum radius of less than about one inch and/or that comprise a panel that is moveably joined to a body of the wall outlet that includes an optical fiber routing guide. The wall outlet further includes at least one optical fiber adapter joined to the body of the wall outlet and/or the moveably joined panel, such that the optical fiber adapter optically connects the optical fiber generally routed through the wall to the optical fiber provided generally outside the wall. The wall outlets of certain embodiments of the present invention define a depth and surface area that allows for convenient installation of the wall outlet in various situations.

One embodiment of the present invention provides a wall outlet adapted for mounting to a wall and for facilitating at least one optical connection between an optical fiber generally routed through the wall and an optical fiber provided generally outside the wall. The wall outlet comprises a body defining an outwardly-facing portion and a wall-facing portion, and the wall-facing portion comprises at least one surface adapted for mounting to the wall. The wall outlet further includes at least one optical fiber adapter joined to the body, wherein the optical fiber adapter is optically connected to the optical fiber generally routed through the wall and provides a receptacle to receive a connector of the optical fiber provided generally outside the wall. In addition, the wall outlet comprises a panel joined to the outwardly-facing portion of the body. The panel comprises at least one optical fiber routing guide adapted to provide slack storage for the optical fiber generally routed through the wall, and the optical fiber routing guide defines a minimum bend radius of less than about one inch. Further embodiments of the present invention include optical fiber routing guides that define a minimum bend radius of less than about half an inch.

Another embodiment of the present invention provides a wall outlet that comprises a body defining an outwardly-facing portion and a wall-facing portion with one surface adapted for mounting to the wall. At least one optical fiber adapter is also included to optically connect the optical fiber generally routed through the wall to a connector of the optical fiber provided generally outside the wall. The wall outlet further comprises a panel moveably joined to the body, wherein the panel comprises at least one optical fiber routing guide adapted to provide slack storage for the optical fiber generally routed through the wall.

The present invention also provides methods for mounting a wall outlet to a wall to facilitate optical connection between an optical fiber generally routed through the wall and an optical fiber provided generally outside the wall. The method comprises providing the optical fiber generally routed through the wall proximate a location to which the wall outlet will be mounted and optically connecting the optical fiber to an optical fiber adapter of the wall outlet. The optical fiber adapter provides a receptacle to also receive a connector of the optical fiber provided generally outside the wall. The method further comprises storing slack of the optical fiber generally routed through the wall, such that optical fiber routing guide defines a minimum bend radius of less than about one inch. The wall outlet may also be removably fastened to the wall.

Therefore, the wall outlets and methods of the various embodiments of the present invention provide for convenient installation of fiber optic wall outlets that provide secure slack storage for the optical fibers.

### BRIEF DESCRIPTION OF THE SEVERAL VIEWS OF THE DRAWINGS

Having thus described the invention in general terms, reference will now be made to the accompanying drawings, which are not necessarily drawn to scale and are meant to be illustrative and not limiting, and wherein:

FIG. 1 is a side elevational view of a prior art wall outlet, illustrating the slack storage in a plane generally orthogonal to the face of the wall outlet;

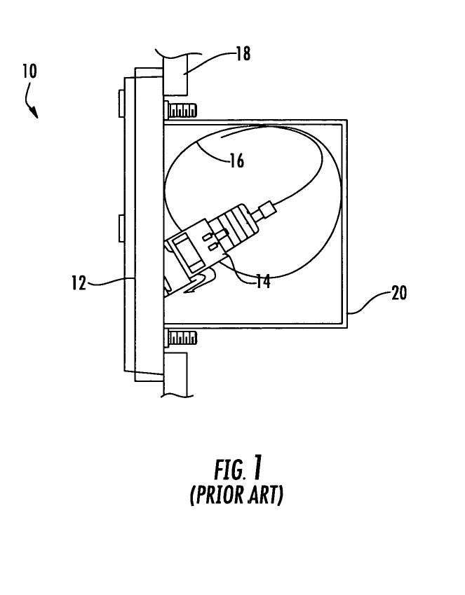

FIG. 2 is a perspective view of an alternative prior art wall outlet, illustrating the internal fiber routing guide;

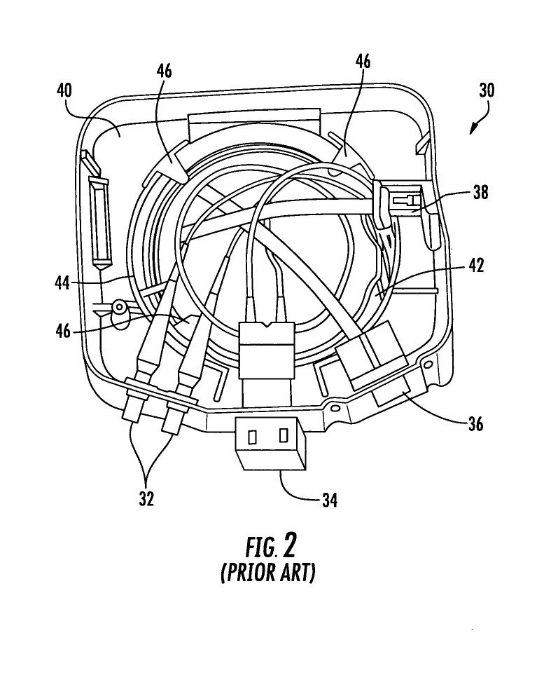

FIG. 3 is a front and side elevational view of a wall outlet in accordance with a first embodiment of the present invention, illustrating the panel and the slack storage defined on a wall-facing surface of the panel;

FIG. 4 is a perspective view of the wall outlet of FIG. 3, illustrating the moveably joined panel and the optical fiber routing guide;

FIG. 5 is a front and side elevational view of a wall outlet in accordance with a second embodiment of the present invention, illustrating a connector of an optical fiber provided generally outside the wall, wherein the slack of the optical fiber is routed around the sides of an outwardly-facing portion of the wall outlet; and

FIG. 6 is a front and side elevational view of a wall outlet in accordance with a third embodiment of the present invention, illustrating a connector of an optical fiber provided generally outside the wall, wherein the slack of the optical fiber is routed generally around the perimeter of an outwardly-facing portion of the wall outlet.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although apparatus and methods for providing a fiber optic wall outlet with slack storage are described and shown in the accompanying drawings with regard to specific types of wall outlets, it is envisioned that the functionality of the various apparatus and methods may be applied to any now known or hereafter devised wall outlet in which it is desired to provide slack storage for optical fibers. Like numbers refer to like elements throughout.

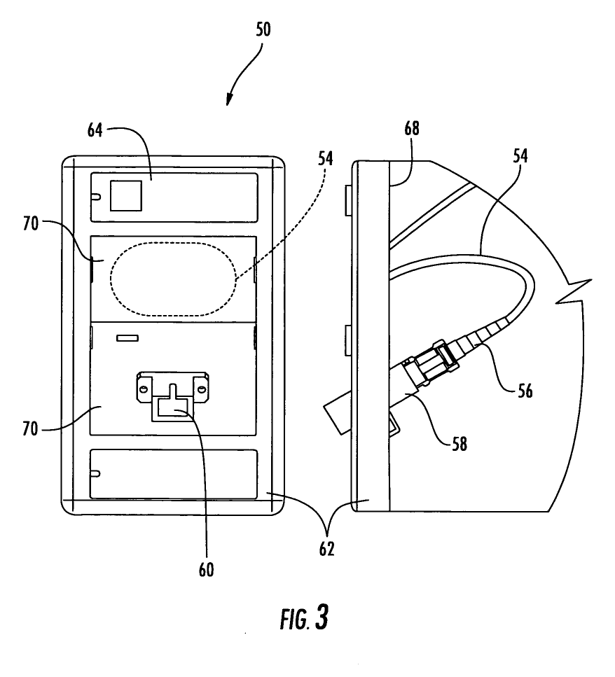

With reference to FIGS. 3-6, wall outlets in accordance with various embodiments of the present invention are illustrated. The wall outlets of the present invention disclosed herein are to be considered non-limiting, as the present invention includes all wall outlets regardless of overall shape, size, number of fibers accommodated, number of adapters, devices for routing fibers, etc. The wall outlets of the illustrated embodiments of the present invention are preferably made of a suitable thermoplastic material; however further embodiments include wall outlets comprising additional and/or alternative materials, such as certain metals, for example.

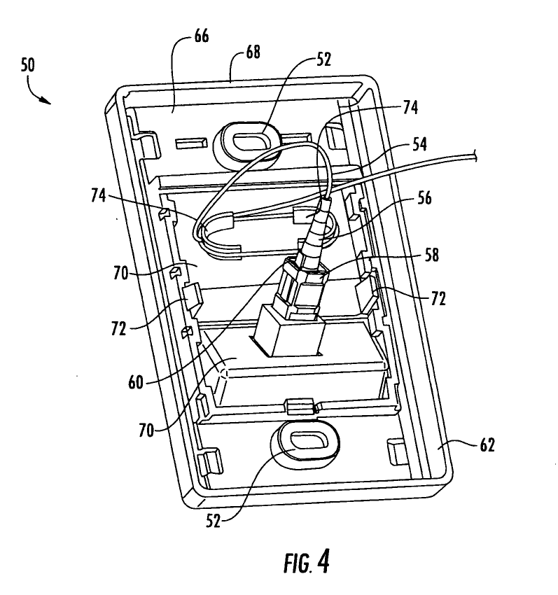

The wall outlet 50 of FIG. 3 is adapted for mounting to a wall, such as a wall comprising drywall and/or cement, to provide non-limiting examples. The wall outlet 50 may be removably fastened to the wall using standard fasteners through one or more openings 52 as shown in FIG. 4. Further embodiments of the present invention comprise alternative openings and/or other features adapted to fasten the wall outlet to a wall. The wall outlet 50 is also adapted to facilitate at least one optical connection between an optical fiber 54 generally routed through the wall and an optical fiber (not shown) provided generally outside the wall. Each optical fiber preferably includes a connector, such as the SC connector 56 of optical fiber 54, to provide one non-limiting example, such that an optical fiber adapter 58 of the wall outlet 50 may receive each of the connectors in a receptacle 60 of the optical fiber adapter to facilitate the optical connection between the two optical fibers. Additional embodiments of the present invention include optical fiber adapters adapted to receive alternative connector types, either currently in use or developed in the future. Examples of such alternative connectors include, but are not limited to LC, MTP, MT-RJ, SC-DC and CON2R-MT type connectors. Furthermore, the optical fiber adapters of the present invention are adapted to facilitate optical connection between any types of optical fiber, including, but not limited to, single mode optical fiber, multi mode optical fiber, bend performance optical fiber, and the like, and between any number of optical fibers, non-limiting examples of numbers of fibers include 1, 2, 6, 12, 24, and the like.

With regards to the optical fibers, some embodiments of the present invention include various types of optical fibers which include, but are not limited to, low bend sensitivity optical fibers, bend optimized optical fibers, and bend insensitive optical fibers, all of which are referred to generically herein as “bend performance optical fiber.” One specific example of bend performance optical fiber is microstructured optical fibers. Microstructured optical fibers comprise a core region and a cladding region surrounding the core region, the cladding region comprising an annular hole-containing region comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than 1400 nm, in other embodiments also greater than 1260 nm. The optical fibers provide a mode field at a wavelength of 1310 nm preferably greater than 8.0 microns, more preferably between 8.0 and 10.0 microns. The microstructured optical fibers of various embodiments define single-mode transmission optical fiber and/or multi-mode transmission optical fiber.

The microstructured optical fiber of some embodiments of the present invention comprises a core region disposed about a longitudinal centerline, and a cladding region surrounding the core region, the cladding region comprising an annular hole-containing region comprised of non-periodically disposed holes, wherein the annular hole-containing region has a maximum radial width of less than 12 microns, the annular hole-containing region has a regional void area percent of less than 30 percent, and the non-periodically disposed holes have a mean diameter of less than 1550 nm.

By “non-periodically disposed” or “non-periodic distribution”, it is meant that when one takes a cross section (such as a cross section perpendicular to the longitudinal axis) of the optical fiber, the non-periodically disposed holes are randomly or non-periodically distributed across a portion of the fiber. Similar cross sections taken at different points along the length of the fiber will reveal different cross-sectional hole patterns, i.e., various cross sections will have different hole patterns, wherein the distributions of holes and sizes of holes do not match. That is, the voids or holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than 95% of and preferably all of the holes exhibit a mean hole size in the cladding for the optical fiber which is less than 1550 nm, more preferably less than 775 nm, most preferably less than about 390 nm. Likewise, it is preferable that the maximum diameter of the holes in the fiber be less than 7000 nm, more preferably less than 2000 nm, and even more preferably less than 1550 nm, and most preferably less than 775=m. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800× and image analysis software, such as ImagePro, which is available from Media Cybernetics, Inc. of Silver Spring, Md., USA.

The optical fiber disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

In one set of embodiments, the core region includes doped silica to provide a positive refractive index relative to pure silica, e.g. germania doped silica. The core region is preferably hole-free. In some embodiments, the core region comprises a single core segment having a positive maximum refractive index relative to pure silica Δ₁ in %, and the single core segment extends from the centerline to a radius R₁. In one set of embodiments, 0.30%<Δ₁<0.40%, and 3.0 μm<R₁<5.0 μm. In some embodiments, the single core segment has a refractive index profile with an alpha shape, where alpha is 6 or more, and in some embodiments alpha is 8 or more. In some embodiments, the inner annular hole-free region extends from the core region to a radius R₂, wherein the inner annular hole-free region has a radial width W12, equal to R2−R1, and W12 is greater than 1 μm. Radius R2 is preferably greater than 5 μm, more preferably greater than 6 μm. The intermediate annular hole-containing region extends radially outward from R2 to radius R3 and has a radial width W23, equal to R3−R2. The outer annular region extends radially outward from R3 to radius R4. Radius R4 is the outermost radius of the silica portion of the optical fiber. One or more coatings may be applied to the external surface of the silica portion of the optical fiber, starting at R4, the outermost diameter or outermost periphery of the glass part of the fiber. The core region and the cladding region are preferably comprised of silica. The core region is preferably silica doped with one or more dopants. Preferably, the core region is hole-free. While not necessary limited, the hole-containing region preferably has an inner radius R2 which is not more than 20 μm. In some embodiments, R2 is not less than 10 μm and not greater than 20 μm. In other embodiments, R2 is not less than 10 μm and not greater than 18 μm. In other embodiments, R2 is not less than 10 μm and not greater than 14 μm. Again, while not being limited to any particular width, the hole-containing region preferably has a radial width W23 which is not less than 0.5 μm. In some embodiments, W23 is not less than 0.5 μm and not greater than 20 μm. In other embodiments, W23 is not less than 2 μm and not greater than 12 μm. In other embodiments, W23 is not less than 2 μm and not greater than 10 μm.

Such fiber can be made to exhibit a fiber cutoff of less than 1400 nm, more preferably less than 1310 nm, a 20 mm macrobend induced loss of less than 0.5 dB/turn, preferably less than 0.1 dB/turn, more preferably less than 0.05 dB/turn, even more preferably less than 0.03 dB/turn, and still more preferably less than 0.02 dB/turn, a 12 mm macrobend induced loss of less than 1 dB/turn, preferably less than 0.5 dB/turn, more preferably less than 0.2 dB/turn, and even more preferably less than 0.1 dB/turn, and still even more preferably less than 0.05 dB/turn, and a 8 mm macrobend induced loss of less than 5 dB/turn, preferably less than 1 dB/turn, more preferably less than 0.5 dB/turn, and even more preferably less than 0.2 dB/turn and still even more preferably less than 0.1 dB/turn. An example of a suitable fiber is a fiber comprising a core region surrounded by a cladding region which comprises randomly disposed voids which are contained within an annular region spaced from the core and positioned to be effective to guide light along the core region.

Additional features of the microstructured optical fibers of additional embodiments of the present invention are described more fully in pending U.S. patent application Ser. No. 11/583,098 filed Oct. 18, 2006, and provisional U.S. patent application Ser. No. 60/817,863 filed Jun. 30, 2006; 60/817,721 filed Jun. 30, 2006; 60/841,458 filed Aug. 31, 2006; and 60/841,490 filed Aug. 31, 2006; all of which are assigned to Corning Incorporated and the disclosures of which are incorporated by reference herein.

Use of such bend performance optical fiber enables the fibers to undergo a minimum bend radius while providing desired optical performance. The wall outlets of the present invention include optical fiber routing guides to provide slack storage for the optical fiber, as described more fully below. Accordingly, some embodiments of the present invention comprise optical fiber routing guides that define a bend radius of between about 0.01 inch to about 1.0 inch (one inch), more preferably between about 0.1 inch and 0.5 inch (half an inch), and still more preferably of about 0.2 inch. The optical fiber routing guides of some embodiments of the present invention do not define a curved routing guide, but do provide for the minimum bend radius of the particular optical fiber, such as bend performance optical fiber, associated with the wall outlet.

Turning again to the wall outlet 50 of FIGS. 3 and 4, the wall outlet comprises a body 62 that defines an outwardly-facing portion 64 and a wall-facing portion 66 opposed thereto. The wall-facing portion 66 comprises at least one surface 68 adapted for mounting to the wall. Alternative embodiments of the present invention include bodies defining portions of different shape and/or surfaces that mount to the wall differently. Joined to the body 62 of the wall outlet 50 of FIGS. 3 and 4 is a panel 70 that in the illustrated embodiment comprises a panel that is movably joined to the body. The panel may define a single or multiple portions (the panel 70 of the illustrated embodiment defines a single portion) and may be located at any position on the wall outlet. The panel 70 of the wall outlet 50 is generally centered in the body 62 in both a horizontal direction and a vertical direction. The optical fiber adapter 58 of the wall outlet 50 is joined to the panel 70 in the illustrated embodiment. The panel 70 of the wall outlet 50 of FIGS. 3 and 4 is removable from the outwardly-facing portion 64 of the body 60 of the wall outlet, as the panel is joined by two tabs 72 that provide for selective removal of the panel by a technician or customer by gripping one or more surface of the panel in a particular fashion to release the notched portion of the tab from the body of the wall outlet. Further embodiments of the present invention include alternative devices for moveably joining the panel to the body. In one particular embodiment, the panel is joined to the outwardly-facing portion of the body, such that the panel is selectively pivotable generally about an axis, such as a horizontal or vertical axis using one or more hinges or the like. Still further embodiments of the present invention comprise panels that are not moveably joined to the body of the wall outlet. The wall outlet 50 of FIGS. 3 and 4 does include a panel 70 that is moveably joined to the body 62 for at least the reason of providing selective access to the slack storage provided on the optical fiber routing guides 74.

The optical fiber routing guides 74 shown in FIG. 4 comprise two generally semicircular portions extending toward the wall from a wall-facing portion of the panel 70. Therefore, the slack storage defines a generally elliptical shape; however, further embodiments of the present invention comprise optical fiber routing guides of alternative shape, size, location, etc. such that the slack storage may define any shape. For example, the at least one optical fiber routing guide of some embodiments routes the slack of the optical fiber such that the optical fiber generally encircles the optical fiber adapter. Turning again to FIG. 4, the optical fiber routing guides 74 provide slack storage for the optical fiber 54 generally routed through the wall on the wall-facing portion of the panel such that the slack storage is not visible from outside the wall outlet 50 without removal of the panel 70 and/or wall outlet. Further embodiments of the present invention provide at least one optical fiber routing guide such that slack storage of the optical fiber is exposed when the wall outlet is fastened to the wall. The optical fiber routing guides 74 of the wall outlet 50 is joined to the panel 70 (such that the panel comprises the optical fiber routing guides); however, further embodiments of the present invention include at least one optical fiber routing guide joined to the body of the wall outlet. Because the optical fiber routing guides 74 of the wall outlet 50 of FIGS. 3 and 4 is joined to the panel 70, a technician and/or customer has convenient access to the slack storage of the optical fiber 54 by merely removing the panel; thus providing more freedom of moving the optical fiber adapter 58 when optically connecting an optical fiber (not shown) provided generally outside the wall outlet to the optical fiber 54 generally routed through the wall and thus allowing more convenient access to the optical fiber 54, the connector 56, and/or adapter 58.

The optical fiber routing guides 74 of FIG. 4 are adapted for use with bend performance optical fiber, such that the optical fiber routing guide defines a minimum bend radius of less than about one inch. Further embodiments of the present invention comprise optical fiber routing guides that define a minimum bend radius of less than about half an inch, while still further embodiments of the present invention comprise optical fiber routing guides that define a minimum bend radius of less than about 0.2 inch. Additional embodiments of the present invention are adapted for use with optical fiber that may not comprise bend performance optical fiber; however, the optical fiber routing guides of such embodiments provides a minimum bend radius adequate to ensure proper performance of the optical fiber (acceptable signal loss based upon the optical fiber bend radius).

One aspect of the present invention is the ability to provide a wall outlet with optical fiber slack storage that is of similar size to standard wall outlets, such as wall outlets for conventional power outlets and/or telephone jacks, thus enabling a technician and/or customer to install the wall outlet more conveniently than conventional fiber optic wall outlets with optical fiber slack storage. For example, the wall outlet 50 of FIGS. 3 and 4 defines a horizontal dimension of about 2.75 inches, a vertical dimension of about 4.50 inches, and a depth (the distance the outwardly-facing portion 64 extends outwardly from the wall when the wall outlet is fastened to the wall) of about 0.5 inch. Furthermore, additional embodiments of the present invention include fiber optic wall outlets that incorporate additional outlets, such as power, telephone, cable, etc. to allow technicians and/or customers the ability to upgrade an existing wall outlet without fiber optic capabilities with a fiber optic wall outlet without installing an entirely new wall outlet. Still further advantages may be realized by further embodiments of the present invention based upon the size, shape, accessibility, and other functions or features of the fiber optic wall outlets of the present invention.

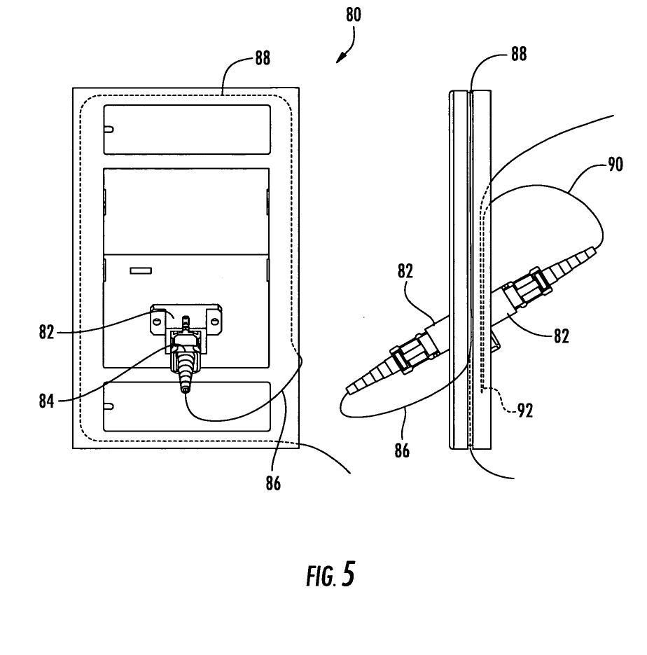

Turning now to the embodiment of FIG. 5, the wall outlet 80 provides a fiber routing guide to store slack of the optical fiber provided generally outside the wall. Similar to the optical fiber adapter 58 of the wall outlet 50 of FIG. 3, the wall outlet 80 comprises an optical fiber adapter 82 adapted to receive a connector 84 of the optical fiber 86 provided generally outside the wall. The optical fiber adapter 82 optically connects the connector 84 with the connector of the optical fiber generally routed through the wall. When the connector 84 is received by the optical fiber adapter 82, the optical fiber 86 may define an amount of slack that may be stored about an optical fiber routing guide 88. The routing guide 88 of FIG. 5 comprises a channel defined in one or more sides of the outwardly-facing portion of the body of the wall outlet. More specifically, the routing guide 88 of FIG. 5 comprises a channel defined in the top, bottom, left, and right sides of the outwardly-facing portion of the body of the wall outlet. The channel of the optical fiber routing guide 88 provides sufficient width and depth to receive at least one winding of the optical fiber, whereas optical fiber routing guides of further embodiments of the present invention define widths and/or depths sufficient to hold any reasonable number of windings of the optical fiber. Although no lead-in, retainer, and/or other features are included in the optical fiber routing guide 88 of FIG. 5; further embodiments of the present invention comprise alternative routing guides with additional and/or different features to route, retain, or otherwise manipulate the optical fiber slack stored about the routing guide. Referring again to the wall outlet 80 of FIG. 5, a technician and/or customer may simply wind the optical fiber 86 about the optical fiber routing guide 88 a desired number of windings and/or partial windings to store a desired amount of slack within the optical fiber routing guide, preferably after the connector 84 has been received by the optical fiber adapter 82. It should also be noted that an optical fiber routing guide of the wall-facing portion of the body of the wall outlet provides for the optical fiber 90 generally routed through the wall slack storage 92 that generally encircles the optical fiber adapter of the wall-facing portion of the body of the wall outlet 80.

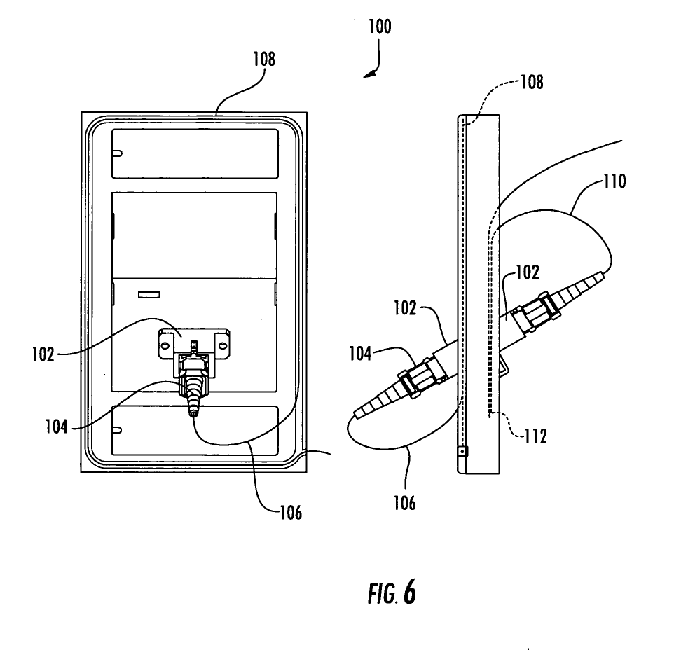

Turning now to the embodiment of FIG. 6, the wall outlet 100 provides a fiber routing guide to store slack of the optical fiber provided generally outside the wall. Similar to the optical fiber adapter 82 of the wall outlet 80 of FIG. 5, the wall outlet 100 comprises an optical fiber adapter 102 adapted to receive a connector 104 of the optical fiber 106 provided generally outside the wall. The optical fiber adapter 102 optically connects the connector 104 with the connector of the optical fiber generally routed through the wall. When the connector 104 is received by the optical fiber adapter 102, the optical fiber 106 may define an amount of slack that may be stored about an optical fiber routing guide 108. The routing guide 108 of FIG. 6 comprises a channel defined generally around the perimeter of an outwardly-facing portion of the wall outlet. More specifically, the routing guide 108 of FIG. 6 comprises a channel defined on the outwardly-facing surface of the outwardly-facing portion and generally proximate the top, bottom, left, and right sides of the outwardly-facing portion of the body of the wall outlet. The channel of the optical fiber routing guide 108 provides sufficient width and depth to receive at least one winding of the optical fiber, whereas optical fiber routing guides of further embodiments of the present invention define widths and/or depths sufficient to hold any reasonable number of windings of the optical fiber. Although no lead-in, retainer, and/or other features are included in the optical fiber routing guide 108 of FIG. 6; further embodiments of the present invention comprise alternative routing guides with additional and/or different features to route, retain, or otherwise manipulate the optical fiber slack stored about the routing guide. Referring again to the wall outlet 100 of FIG. 6, a technician and/or customer may simply wind the optical fiber 106 about the optical fiber routing guide 108 a desired number of windings and/or partial windings to store a desired amount of slack within the optical fiber routing guide, preferably after the connector 104 has been received by the optical fiber adapter 102. It should also be noted that an optical fiber routing guide of the wall-facing portion of the body of the wall outlet provides for the optical fiber 110 generally routed through the wall slack storage 112 that generally encircles the optical fiber adapter of the wall-facing portion of the body of the wall outlet 100.

The present invention also provides methods for mounting a wall outlet to a wall to facilitate optical connection between an optical fiber generally routed through the wall and an optical fiber provided generally outside the wall. With reference to the wall outlet 50 of FIGS. 3 and 4, the method comprises providing the optical fiber 54 generally routed through the wall proximate a location to which the wall outlet 50 will be mounted and optically connecting the optical fiber to an optical fiber adapter 58 of the wall outlet. The optical fiber adapter 58 provides a receptacle 60 to also receive a connector of the optical fiber (not shown) provided generally outside the wall. The method further comprises storing slack of the optical fiber 54 generally routed through the wall, such that the optical fiber routing guide 74 defines a minimum bend radius of less than about one inch. The wall outlet 50 may also be removably fastened to the wall using suitable fasteners that are inserted through the one or more openings 52 of the wall outlet. The method of some embodiments of the present invention include selectively moving the panel 70 of the wall outlet 50 relative to the body 62 of the wall outlet, particularly in the embodiments where the panel comprises the optical fiber routing guides 74. Still further embodiments of the present invention comprise alternative methods for mounting a fiber optic wall outlet to a wall to facilitate optical connectivity and/or to provide optical fiber slack storage.

With reference to the wall outlets 80 and 100 of FIGS. 5 and 6, various methods of the present invention also comprise methods for storing slack of the optical fiber provided generally outside the wall. The method comprises at least partially inserting a connector 84, 104 into an optical fiber adapter 82, 102 and winding the optical fiber 86, 106 about an optical fiber routing guide 88, 108 defined on an outwardly-facing portion of the body of the wall outlet. Still further embodiments of the present invention provide alternative methods for providing slack storage of an optical fiber provided generally outside a wall.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

1. A wall outlet adapted for mounting to a wall and for facilitating at least one optical connection between an optical fiber generally routed through the wall and an optical fiber provided generally outside the wall, the wall outlet comprising:
a body defining an outwardly-facing portion and a wall-facing portion opposed thereto, wherein the wall-facing portion comprises at least one surface adapted for mounting to the wall and the outwardly-facing portion comprises a face of the wall outlet;
at least one optical fiber adapter joined to the body, wherein the optical fiber adapter is adapted for optically connecting to the optical fiber generally routed through the wall and provides a receptacle to receive a connector of the optical fiber provided generally outside the wall; and
a panel joined to the body, wherein the panel comprises at least one optical fiber routing guide adapted to provide slack storage for the optical fiber generally routed through the wall and wherein at least one optical fiber routing guide is defined on a wall-facing surface of the panel;
wherein the optical fiber routing guide defines a minimum bend radius of less than about one inch.

2. A wall outlet according to claim 1, wherein the optical fiber routing guide defines a minimum bend radius of less than about half an inch.

3. (canceled)

4. A wall outlet according to claim 1, wherein the panel is pivotably joined to the outwardly-facing portion of the body, such that the panel is selectively pivotable generally about an axis.

5. A wall outlet according to claim 1, wherein the panel is selectively removable from the outwardly-facing portion of the body.

6. A wall outlet according to claim 1, wherein the optical fiber routing guide is adapted for use with bend performance optical fiber.

7. A wall outlet according to claim 1, wherein the at least one optical fiber routing guide provides slack storage that generally defines an elliptical shape.

8. A wall outlet according to claim 1, wherein the body of the wall outlet defines a perimeter of the outwardly-facing portion that is about 2.75 inches by about 4.50 inches.

9. A wall outlet according to claim 1, wherein the body of the wall outlet defines a depth of the outwardly-facing portion extending beyond the wall to which the wall outlet is mounted of about 0.5 inch.

10. A wall outlet adapted for mounting to a wall and for facilitating at least one optical connection between an optical fiber generally routed through the wall and an optical fiber provided generally outside the wall, the wall outlet comprising:
a body defining an outwardly-facing portion and a wall-facing portion opposed thereto, wherein the wall-facing portion comprises at least one surface adapted for mounting to the wall and the outwardly-facing portion comprises a face of the wall outlet;
at least one optical fiber adapter, wherein the optical fiber adapter is adapted for optically connecting to the optical fiber generally routed through the wall and provides a receptacle to receive a connector of the optical fiber provided generally outside the wall; and
a panel moveably joined to the body, wherein the panel comprises at least one optical fiber routing guide adapted to provide slack storage for the optical fiber generally routed through the wall, the at least one optical fiber routing guide configured so that the slack storage is about a plane that is generally parallel to the face of the wall outlet.

11. A wall outlet according to claim 10, wherein the at least one optical fiber routing guide is defined on a wall-facing surface of the panel.

12. A wall outlet according to claim 10, wherein the optical fiber adapter is joined to the panel.

13. A wall outlet according to claim 10, wherein the panel is pivotably joined to the outwardly-facing portion of the body, such that the panel is selectively pivotable generally about an axis.

14. A wall outlet according to claim 10, wherein the panel is selectively removable from the outwardly-facing portion of the body.

15. A wall outlet according to claim 10, wherein the at least one optical fiber routing guide provides slack storage that generally defines an elliptical shape.

16. A wall outlet according to claim 10, wherein the at least one optical fiber routing guide provides slack storage that generally encircles the optical fiber adapter.

17. A method of mounting a wall outlet to a wall to facilitate at least one optical connection between an optical fiber generally routed through the wall and an optical fiber provided generally outside the wall, the method comprising:
providing the optical fiber generally routed through the wall, wherein at least one end of the optical fiber generally routed through the wall is provided proximate a location to which the wall outlet will be mounted;
optically connecting the optical fiber generally routed through the wall to an optical fiber adapter of the wall outlet, wherein the optical fiber adapter provides a receptacle to receive a connector of the optical fiber provided generally outside the wall;
storing slack of the optical fiber generally routed through the wall so that the slack is stored in an area having a depth of about 0.5 inch from an outer face of the outlet, wherein the slack storage is provided by at least one optical fiber routing guide of a panel and wherein the optical fiber routing guide defines a minimum bend radius of less than about one inch; and
removably fastening the wall outlet to the wall.

18. A method according to claim 17, further comprising selectively moving a panel of the wall outlet relative to the body of the wall outlet, wherein the panel comprises the at least one optical fiber routing guide.

19. A method according to claim 18, wherein selectively moving the panel of the wall outlet relative to the body of the wall outlet comprises selectively removing the panel from the body of the wall outlet.

20. A method according to claim 17, wherein storing the slack of the optical fiber comprises routing the optical fiber generally routed through the wall such that the optical fiber generally encircles the optical fiber adapter.

21. A wall outlet adapted for mounting to a wall and for facilitating at least one optical connection between an optical fiber generally routed through the wall and an optical fiber provided generally outside the wall, the wall outlet comprising:
a body defining an outwardly-facing portion and a wall-facing portion opposed thereto, wherein the wall-facing portion comprises at least one surface adapted for mounting to the wall;
at least one optical fiber adapter, wherein the optical fiber adapter is adapted for optically connecting to the optical fiber generally routed through the wall and provides a receptacle to receive a connector of the optical fiber provided generally outside the wall; and
at least one optical fiber routing guide provided on the wall-facing portion of the body of the wall outlet, wherein the at least one optical fiber routing guide is adapted to provide slack storage for the optical fiber provided generally outside the wall.

22. A wall outlet according to claim 21, further comprising at least one optical fiber routing guide provided on the outwardly-facing portion of the body of the wall outlet, wherein the at least one optical fiber routing guide is adapted to provide slack storage for the optical fiber generally routed through the wall.

23. A wall outlet according to claim 21, further comprising a panel moveably joined to the body, wherein the at least one optical fiber adapter is joined to the panel and wherein the at least one optical fiber routing guide provided on the wall-facing portion generally encircles the panel.

24. A wall outlet according to claim 21, wherein at least one optical fiber routing guide provided on the wall-facing portion of the body of the wall outlet comprises a channel defined in one or more sides of the outwardly facing portion of the body of the wall outlet.

25. A wall outlet according to claim 21, wherein at least one optical fiber routing guide provided on the wall-facing portion of the body of the wall outlet comprises a channel defined generally around the perimeter of an outwardly-facing portion of the wall outlet.

26. A wall outlet adapted for mounting to a wall and for facilitating at least one optical connection between an optical fiber generally routed through the wall and an optical fiber provided generally outside the wall, the wall outlet comprising:
a body defining an outwardly-facing portion and a wall-facing portion opposed thereto, wherein the wall-facing portion comprises at least one surface adapted for mounting to the wall and the outwardly-facing portion comprises a face of the wall outlet;
at least one optical fiber adapter, wherein the optical fiber adapter is optically connected to the optical fiber generally routed through the wall and provides a receptacle to receive a connector of the optical fiber provided generally outside the wall; and
at least one optical fiber routing guide adapted to provide slack storage for the optical fiber generally routed through the wall so that the slack storage is about a plane that is generally parallel to the face of the wall outlet;
wherein the at least one optical fiber routing guide is adapted to provide slack storage for a microstructured optical fiber comprising a core region and a cladding region surrounding the core region, the cladding region comprising an annular hole-containing region comprised of non-periodically disposed holes.

27. A wall outlet according to claim 26, wherein the microstructured fiber has a 12 mm macrobend induced loss at 1550 nm of less than 0.1 dB/turn.

28. A wall outlet according to claim 26, wherein the microstructured fiber has a 12 mm macrobend induced loss at 1550 nm of less than 0.05 dB/turn.

29. A wall outlet according to claim 26, wherein the microstructured fiber has a 8 mm macrobend induced loss at 1550 nm of less than 0.2 dB/turn.

30. A wall outlet according to claim 26, wherein the microstructured fiber has a 8 mm macrobend induced loss at 1550 nm of less than 0.1 dB/turn.
